(19) United States
(12) Patent Application Publication
(10) Pub. No.: US 2005/0202820 A1
(43) Pub. Date: Sep. 15, 2005

(54) Standby application providing server

(75) Inventor: Kazuto Washio, Saitama-shi (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/075,809

(22) Filed: Mar. 10, 2005

(30) Foreign Application Priority Data
Mar. 12, 2004 (JP) 2004-70960

(51) Int. Cl. H04Q 7/20

(52) U.S. Cl. 455/435.3; 455/435.1

(57) ABSTRACT

According to the present invention, a unique standby application can be transmitted to a mobile telephone based on an uploaded image and a component selected by the mobile telephone. Therefore, the user of the mobile telephone can generate a unique standby application by combining a desired image and a component. Moreover, the combination of an image and a component as a selection result can be confirmed from the data indicating them, thereby avoiding the waste of transmitting a standby application not desired by a user. Furthermore, the combination of an image and a component as a selection result can be confirmed from an image, graphic data, and voice indicating them.

### BACKGROUND OF THE INVENTION

1. Field of the Invention

The present invention relates to a standby application providing server of a mobile telephone, and more specifically to a standby application providing server capable of selecting a component of a standby application from the mobile telephone.

2. Description of the Related Art

Recently, a service of distributing an application using an image to a mobile telephone has become widespread. For example, according to Japanese Patent Application Laid-open No. 2003-10553, the information designating the type of game program from a personal computer and an image for use in the game are transmitted to a server, and the server transmits the designated game and a resized image to the mobile telephone. Thus, a user can enjoy a game using a desired image on the user's mobile telephone.

### SUMMARY OF THE INVENTION

However, Japanese Patent Application Laid-open No. 2003-10553 can use a desired image in a game, but does not concretely disclose the technology of arbitrarily selecting by a user a component of a standby application. The present invention has been developed to solve the problems with the conventional techniques and aims at providing a server capable of selecting components of various standby applications.

To achieve the above-mentioned objects, a first aspect of the present invention is a server for providing a standby application for a mobile telephone, comprising: an image receiving device which receives uploading an image used in the standby application; a component selection device which displays a selection input screen for selection of a component configuring the standby application on the mobile telephone, and receives a selection result of the component based on a selection input operation to the selection input screen; and a transmitting device which transmits a unique standby application to the mobile telephone based on the received image and the selection result of the component.

According to the first aspect, a unique standby application can be transmitted to a mobile telephone based on an uploaded image and a component selected by the mobile telephone. Therefore, the user of the mobile telephone can generate a unique standby application by combining a desired image and a component.

A second aspect of the present invention is based on the server according to the first aspect, and the transmitting device transmits data indicating the received image and the selection result of the component to the mobile telephone.

According to the second aspect, the combination of an image and a component as a selection result can be confirmed from the data indicating them, thereby avoiding the waste of transmitting a standby application not desired by a user.

A third aspect of the present invention is based on the server according to the second aspect, and the data comprises one or image data, graphic data, and audio data.

According to the third aspect, the combination of an image and a component as a selection result can be confirmed from an image, graphic data, and voice indicating them.

A fourth aspect of the present invention is based on the server according to the second or third aspect, further comprises a transmission confirmation device which displays a confirmation screen for reception of an input to confirm whether or not the unique standby application can be transmitted, and receives information as to whether or not the application can be transmitted based on a confirmation inputting operation to the confirmation screen, and the transmitting device transmits the unique standby application to the mobile telephone based on a confirmation input result to the confirmation screen.

According to the fourth aspect, the combination of an image and a component as a selection result can be confirmed from the data indicating them, and, based on the result, it can be selected whether or not a unique standby application is to be transmitted. Therefore, it is possible to prevent transmitting of a standby application when the combination of an image and a component as a selection result is not desired by a user.

According to the above-mentioned aspects of the present invention, a unique standby application can be transmitted to a mobile telephone based on an uploaded image and a component selected by the mobile telephone. Therefore, the user of the mobile telephone can generate a unique standby application by combining a desired image and a component.

### BRIEF DESCRIPTION OF THE DRAWINGS

FIG. 1 shows the configuration of a block diagram of the image service system according to a preferred embodiment of the present invention;

FIG. 2 is a block diagram showing the function of the mobile telephone;

FIGS. 3A to 3B are block diagrams showing a standby application generation application and a clock application;

FIG. 4 is a flowchart showing the flow of the standby application transmitting process; and

FIG. 5 shows the component of a clock application.

### DETAILED DESCRIPTION OF THE PREFERRED EMBODIMENTS

The preferred embodiments of the present invention are explained below by referring to the attached drawings.

### First Embodiment

[Outline of the Configuration]

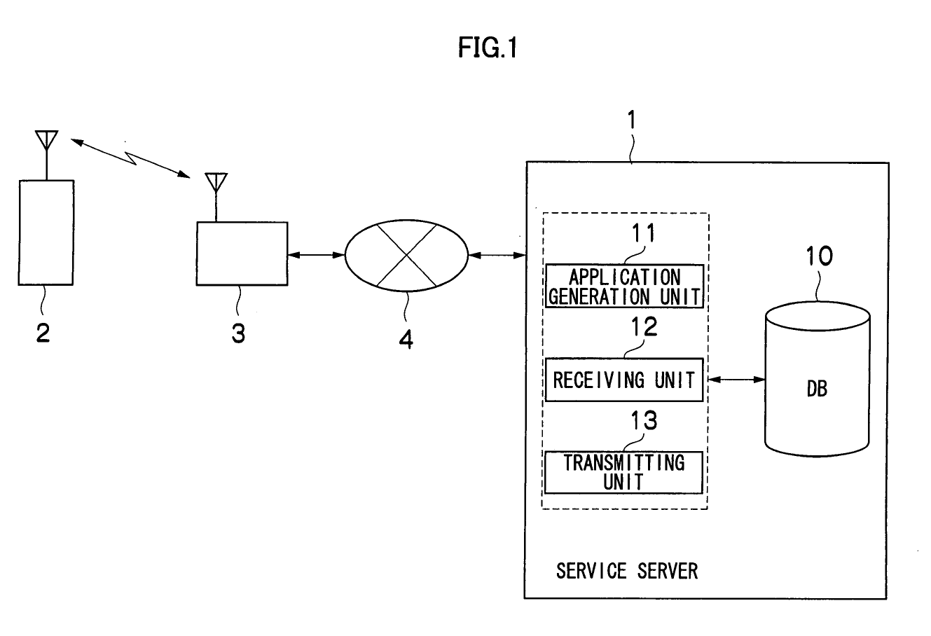

FIG. 1 shows the configuration of the block diagram of the image service system according to a preferred embodiment of the present invention. The system comprises a service server 1 connected to a network 4 such as the Internet by wireless, a mobile telephone 2, and a radio base station 3 wirelessly connected to the mobile telephone 2 for connection of the mobile telephone 2 to the network 4. The service server 1 comprises a database (DB) 10, an application generation unit 11, a receiving unit 12, and a transmitting unit 13.

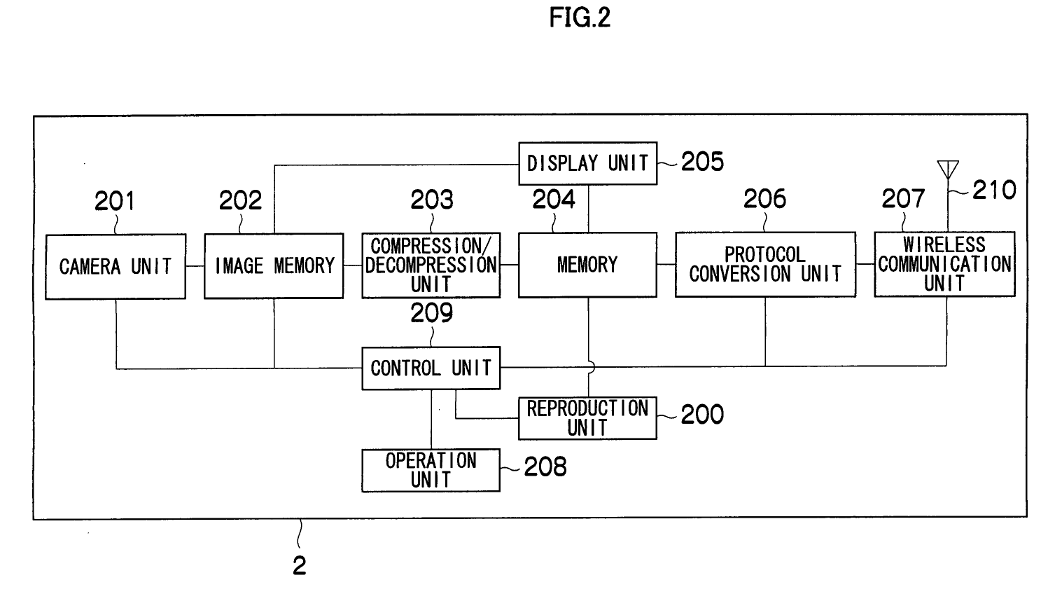

FIG. 2 is a block diagram of the mobile telephone 2. The mobile telephone 2 comprises a camera unit 201, an image memory 202, a compression/decompression unit 203, a memory 204, a display unit 205, a protocol conversion unit 206, a wireless communication unit 207, an operation unit 208, a control unit 209, and a reproduction unit 200. The mobile telephone 2 also comprises a microphone, a speaker, etc. for functioning as a common mobile telephone, but they are omitted in FIG. 2. The control 30 unit 209 is connected to each circuit block of the mobile telephone 2, and controls each block at an instruction signal input from the operation unit 208 including operation keys such as a ten key. When a shutter button provided on the operation unit 208 is pressed, the control unit 209 instructs the camera unit 201 to start capturing an image, and the camera unit 201 performs capturing an image. The camera unit 201 converts the captured image information to electronic image data, and stores the data in the image memory 202. The image data of the image memory 202 can be displayed on the display unit 205 configured by a liquid crystal screen, etc. The image data is compressed by the compression/decompression unit 203, and stored in the memory 204. To the image data stored in the memory 204, destination information (for example, an IP address of the receiving unit 12), unique source information (for example, a user ID uniquely assigned to the mobile telephone 2), etc. are added to the header information in the protocol conversion unit 206, and the data is transmitted to the wireless communication unit 207 according to a predetermined protocol. The image data transmitted to the wireless communication unit 207 is transmitted from the antenna 210 to the receiving unit 12, etc. through the radio base station 3. The source information is stored in the ROM which is an aspect of the memory 204. The reproduction unit 200 reproduces audio data through a speaker not shown in the attached drawings based on the digital audio data stored in the memory 204.

The mobile telephone 2 accesses the transmitting unit 13 designated by a specific URL (uniform resource locator), downloads various applications such as a Java (registered trademark) application, etc., and stores them in the memory 204. The control unit 209 executes the applications stored in the memory 204. In the present embodiment, the applications downloaded from the DB 10 are resident applications which can be constantly executed when power is supplied to the mobile telephone 2, that is, during operation after being activated. Hereinafter, the applications are referred to as standby applications. A standby application can be downloaded by a specific mobile telephone 2, or by any mobile telephone 2. For example, an authentication server can be provided on the service server 1 so that only the mobile telephone 2 authenticated using a user ID and a password can download a standby application. Furthermore, any method of downloading a standby application can be used. For example, the transmitting unit 13 can transmit the mail hyperlinked to the URL which is a download site of a standby application to the mobile telephone 2 authenticated as described above. The mobile telephone 2 can receive the mail, and access the transmitting unit 13 through the hyperlink of the mail to download the standby application. Furthermore, the receiving unit 12 can receive uploading the image data from the mobile telephone 2, store the uploaded image data in the DB 10, but also can receive uploading the image captured by the digital camera from a personal computer, etc. connected to the network 4, and store the data in the DB 10.

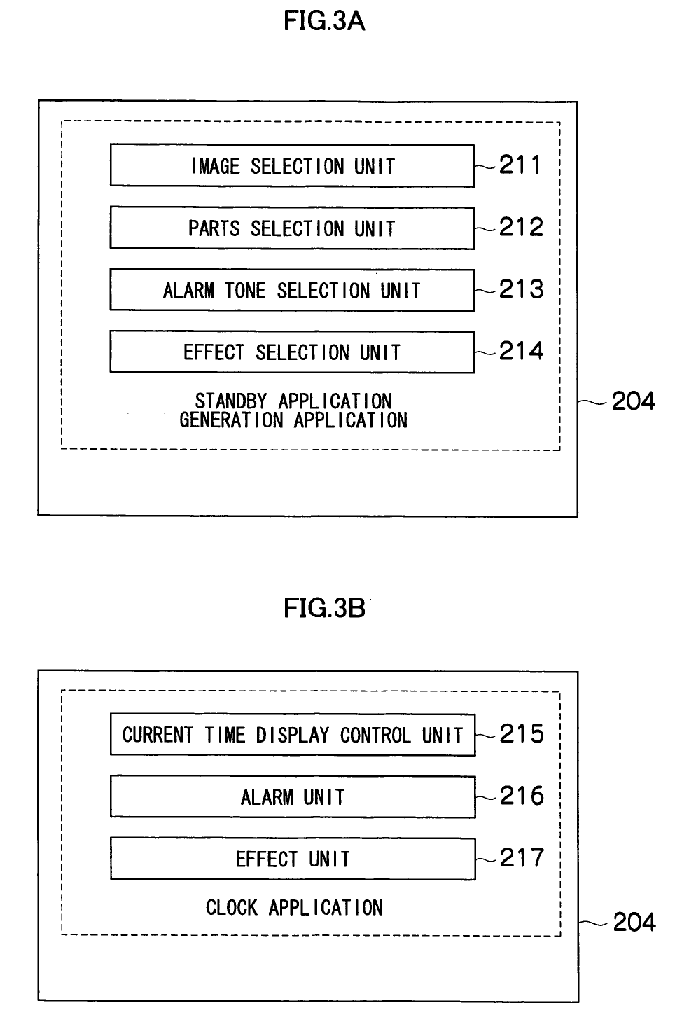

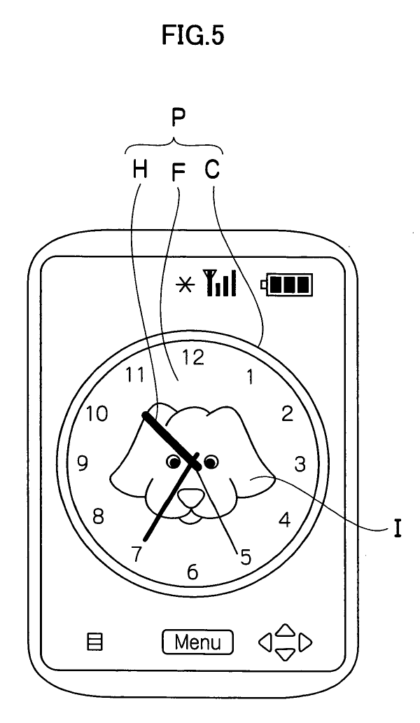

In the present embodiment, the standby application transmitted from the service server 1 to the mobile telephone 2 is a clock application for display of the current time. That is, as shown in FIGS. 3B and 5, the clock application allows the control unit 209 to function as a current time display control unit 215 for display of the current time by drawing clock hand H on the dial F with the lapse of time, an alarm unit 216 for reproducing an alarm tone from the reproduction unit 200 at a set time, and an effect unit 217 for allowing the display unit 205 to display a special image when the alarm tone is reproduced. The settings of the reproduction time of the alarm tone are received from the operation unit 208.

[Standby Application Transmitting Process]

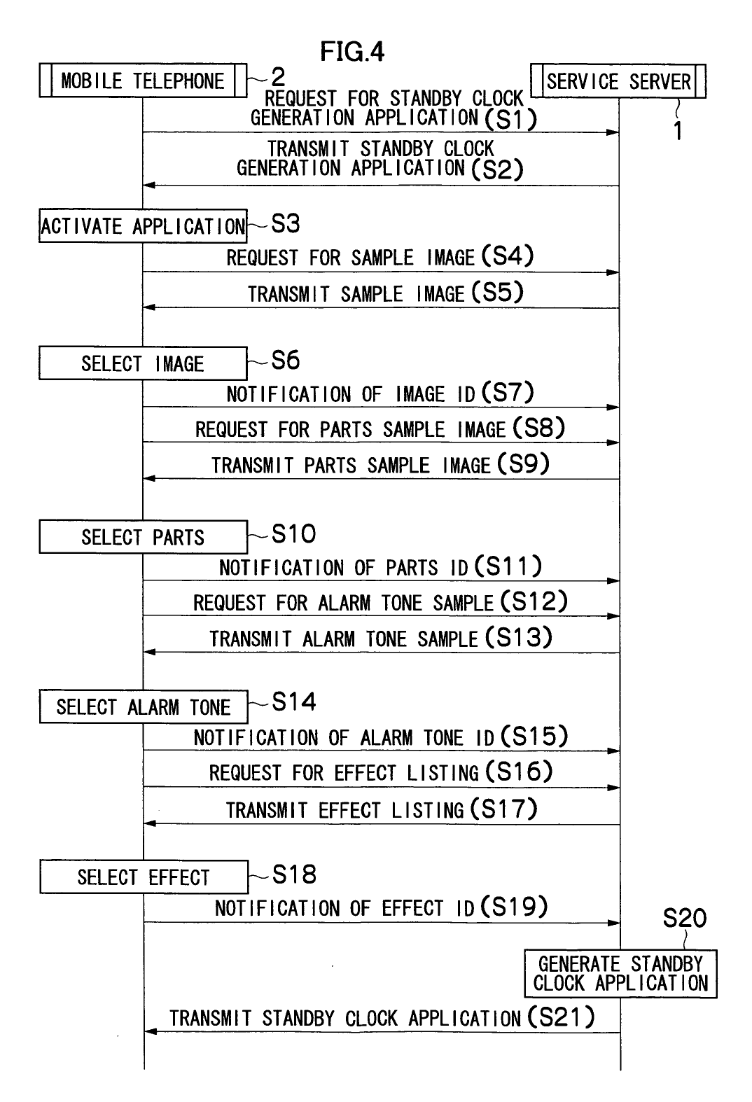

Next, by referring to FIG. 4, the flow of the standby application transmitting process performed between the service server 1 and the mobile telephone 2 is explained below. In this process, as shown in FIG. 5, the dial F, the components of the clock application, that is, the clock hand H, the case C (hereinafter referred to collectively as parts P), an alarm tone, the effect selected when the alarm tone is extended, and the image I which is the background of the dial F, are received in the operation to the operation unit 208, the standby application generation application which is the application for notifying the service server 1 of the selection result is transmitted to the mobile telephone 2, the standby application generation application selects the component and the image of the clock application, and notifies the service server 1 of the result, and the service server 1 transmits the clock application corresponding to the selected component and image to the mobile telephone 2. Hereinafter, the standby application generation application is referred to simply as a generation application.

In S1, the mobile telephone 2 requests the transmission of a generation application. In S2, in response to the request to send from the mobile telephone 2, the transmitting unit 13 transmits the generation application stored in the DB 10 to the mobile telephone 2. In S3, the mobile telephone 2 stores the received generation application in the memory 204, and the control unit 209 activates the generation application in the memory 204. The activation of the generation application can be started upon termination of reception, and can be started by a predetermined operation of the operation unit 208. Afterwards, as shown in FIG. 3A, when the generation application stored in the memory 204 is activated, the control unit 209 is allowed to function as an image selection unit 211, a parts selection unit 212, an alarm tone selection unit 213, and an effect selection unit 214.

In S4, the image selection unit 211 requests the transmission of a sample image of an image I which is the background of the dial F. In S5, the transmitting unit 13 transmits a sample image to the mobile telephone 2. A sample image is an image I obtained by performing various processing such as a compressing, resizing, shape changing process, etc. on an original image captured by, for example, the camera unit 201 and a digital camera not shown in the attached drawings, transmitted to the receiving unit 11 of the service server 1 from the wireless communication unit 207, and stored in the DB 10 to a size in which the image can be recognized by the display unit 205 of the mobile telephone 2. The original image and the sample image are associated with each other and stored in the DB 10, and the sample image has in its header of an image file a unique identifier for designation of a corresponding original image. In S6, the image selection unit 211 stores the received sample image in the memory 204, and displays the sample image on the display unit 205. When there are a plurality of sample images, the sample images can be switched by the operation of the operation unit 208. The image selection unit 211 receives a desired sample image from among displayed sample images in the operation of the operation unit 208. In S7, the image selection unit 211 notifies the service server 1 of the identifier of the original image corresponding to the sample image received as a selection result.

In S8, the parts selection unit 212 requests the service server 1 to transmit a sample image indicating the parts P. In S9, the transmitting unit 13 transmits the sample image indicating the parts P to the mobile telephone 2. A sample image indicating the parts P refers to an image indicating the parts P displayed as graphics as the components of a standby clock such as an image of clock hands H comprising a short hand, a long hand, and a second hand, an image of the dial F, an image of a case C, etc. Therefore, when an actual standby clock is activated, for example, the clock hand H is drawn on the display unit 205 by the application with the lapse of time, but the sample image of a short hand can be, for example, a still image indicating 0 second. In S10, the parts selection unit 212 stores a received sample image in the memory 204, and displays the sample image on the display unit 205. When there are a plurality of sample images, the operation unit 208 can perform an operation of switching the sample images. The parts selection unit 212 receives from the operation unit 208 a desired sample image from among the displayed sample images. In S11, the parts selection unit 212 notifies the service server 1 of the identifier of the parts P corresponding to the selected sample image. The identifier of the parts P is stored in the header of the sample image file as described above, and the standby application draws the parts P corresponding to the notified identifier.

In S12, the alarm tone selection unit 213 requests the service server 1 to transmit digital data (alarm tone data) for reproducing an alarm tone. In S13, the transmitting unit 13 transmits the alarm tone data stored in the DB 10 to the mobile telephone 2. In S14, the alarm tone selection unit 213 stores the received alarm tone data in the memory 204, and the reproduction unit 200 reproduces an alarm tone based on the alarm tone data. When there are a plurality of alarm tones, the operation unit 208 can operate to switch the alarm tone to be reproduced. The alarm tone selection unit 213 receives a desired alarm tone by the operation of the operation unit 208. In S15, the alarm tone selection unit 213 notifies the service server 1 of the identifier of the selected alarm tone. The identifier of the alarm tone is stored in the header of the alarm tone data as described above.

In S16, the effect selection unit 214 requests the service server 1 for a listing document of effects. In S17, the transmitting unit 13 transmits a listing document stored in the DB 10 to the mobile telephone 2. In S18, the effect selection unit 214 stores the received listing document in the memory 204, and displays the listing document on the display unit 205. The effect selection unit 214 receives a desired effect from among the effects displayed in the listing document in the operation of the operation unit 208. In S19, the effect selection unit 214 notifies the service server 1 of the identifier of the selected effect. The identifier of an effect is, for example, embedded as a hyperlink corresponding to each effect of the listing document described by the HTML.

In S20, the application generation unit 11 displays the current time using the parts P designated by the parts ID selected in S11, displays the image I designated by the image ID notified in S7 as the background of the parts P, reproduces an alarm tone designated by the alarm tone ID notified in S15 at a set time, and generates a clock application for displaying an effect designated by the effect ID notified in S19 when the alarm tone is reproduced. In S21, the transmitting unit 13 transmits the clock application generated in S12 to the mobile telephone 2. The mobile telephone 2 stores the received clock application in the memory 204. A clock application having the facilities corresponding to the possible combinations of all images I, parts P, alarm tones, and effects can be stored in advance in the DB 10, and the clock application having the facilities corresponding to the notified image ID, parts ID, alarm tone ID, and effect ID can be designated from the DB 10 and transmitted. Before transmitting the clock application, the sample image indicating the combination of the image I and the parts P as shown in FIG. 5 can be transmitted to the mobile telephone 2 and displayed on the display unit 205, and the user can confirm the display contents and input the agreement of the transmission through the operation unit 208 so that a clock application can be transmitted.

In the processes described above, the mobile telephone 2 selects desired image I, parts P, alarm tone, and effect, and the clock application having the selected facilities is transmitted. Therefore, a user's preferred clock application can be provided.

### Other Embodiments

In addition to the clock application according to the first embodiment, a standby application generation application can select the components of various standby applications. For example, when a standby application is a calendar application for display of the current year, month, day, day of week on the display unit 205, the parts selection unit 212 selects the components, that is, the ornaments such as the font and color of the characters describing the year, month, day, day of week, and notifies the service server 1 of the identifier of the selected parts. The image selection unit 211 selects an image to be displayed as the background of the display of the current year, month, day, day of week as in the first embodiment, and notifies the service server 1 of the identifier of the image. The service server 1 generates a calendar application having the components and image identified by the notified identifier, and transmits the calendar application to the mobile telephone 2. In the second embodiment, the alarm tone selection unit 213 and the effect selection unit 214 do not have to store data in the memory 204, but the effect selection unit 214 can select the image to be displayed as an effect on a specific date such as a birthday, etc.

1. A standby application providing server which provides a standby application for a mobile telephone, comprising:
an image receiving device which receives uploading an image used in the standby application;
a component selection device which displays a selection input screen for selection of a component configuring the standby application on the mobile telephone, and receives a selection result of the component based on a selection input operation to the selection input screen; and
a transmitting device which transmits a unique standby application to the mobile telephone based on the received image and the selection result of the component.

2. The standby application providing server according to claim 1, wherein
the transmitting device transmits data indicating the received image and the selection result of the component to the mobile telephone.

3. The standby application providing server according to claim 2, wherein
the data comprises one or image data, graphic data, and audio data.

4. The standby application providing server according to claim 2, further comprising:
a transmission confirmation device which displays a confirmation screen for reception of an input to confirm whether or not the unique standby application can be transmitted, and receives information as to whether or not the application can be transmitted based on a confirmation inputting operation to the confirmation screen, wherein
the transmitting device transmits the unique standby application to the mobile telephone based on a confirmation input result to the confirmation screen.

5. The standby application providing server according to claim 3, further comprising:
a transmission confirmation device which displays a confirmation screen for reception of an input to confirm whether or not the unique standby application can be transmitted, and receives information as to whether or not the application can be transmitted based on a confirmation inputting operation to the confirmation screen, wherein
the transmitting device transmits the unique standby application to the mobile telephone based on a confirmation input result to the confirmation screen.
